(19) United States
(12) Patent Application Publication
(10) Pub. No.: US 2006/0253559 A1
(43) Pub. Date: Nov. 9, 2006

(54) Discovering proximate apparatus and services in a wireless network

(75) Inventors: Javier Espina Perez, Aachen (DE); Thomas Falck, Aachen (DE); Henning Maass, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/551,030

(22) PCT Filed: Mar. 25, 2004
(86) PCT No.: PCT/IB04/01014

§ 371 Date: Sep. 29, 2005

(30) Foreign Application Priority Data
Apr. 4, 2003 (EP) 03100901.2

(51) Int. Cl. G06F 15/177

(52) U.S. Cl. 709/222; 370/218; 370/338; 358/1.15

(57) ABSTRACT

A searching apparatus is put into the position of identifying the available apparatuses and services in its proximity in that an apparatus to be discovered periodically separates itself from its Access Point and builds up its own Ad hoc Network (AHN) which can be recognized via its Service Set Identifier (SSID) by the searching apparatus.

The invention relates to a method of enabling apparatuses in a wireless network (wireless LAN, WLAN) to discover other apparatuses and services in their proximity.

Wireless networks in spatially bounded areas (referred to as local area networks, LAN) are used within very wide fields. A field of application is, for example, computer-LAN in which a plurality of computers and a plurality of peripheral apparatuses such as printers, scanners, projectors, etc. are combined. These LANs are widely used in, for example, companies. They usually have a plurality of Access Points (AP) via which a user can connect to a portable WLAN-capable apparatus in the network and can thus use, for example, the company's main frame computer. Moreover, the use of generally available peripheral apparatuses such as printers, scanners, UHP projectors, etc. is made possible in that they are also connected to the network and can be accessed by several users. This provides the possibility of, for example, the fixed installation of the peripheral apparatuses in conference rooms, in which a lecturer or speaker only needs to connect his laptop to the network for communication with the peripheral apparatus.

This poses the problem that the apparatus which is in closest proximity must be occasionally selected from a plurality of equivalent apparatuses. For example, when a user with a laptop searches a printer in a building which is unknown to him, he is interested in finding the printer which is in closest proximity to his current location, rather than a printer which may be present in another building or on another floor.

The current Discovery Frameworks such as, for example, Universal Plug&Play (UPnP) provide the possibility of discovering apparatuses and services which can be reached via the network or are available in the network. However, in the current state of the art, it is not possible to limit the discovery of apparatuses and services to locally proximate apparatuses and services.

A search by means of Universal Plug&Play (UPnP) will thus find all appropriate apparatuses and services which are present in the same network. Consequently, the number of discovered apparatuses may be relatively large, dependent on the WLAN size. Without further information about the distance between the apparatuses discovered by means of Universal Plug&Play (UPnP), the user cannot know which apparatuses are spatially most proximate to him.

The network with which a WLAN-capable apparatus is connected usually consists of a plurality of Basic Service Sets (BSSs) which are interconnected by a distribution system (DS). Each Access Point (AP) and the apparatuses connected thereto constitute a Basic Service Set (BSS). An apparatus connected to an Access Point (AP) can query a list of different available Service Sets (SSs) within the range of its WLAN transceiver (about 100 meters), without separating itself from the AP. The list states a series of Access Points (as BSSs) and possibly Ad Hoc Networks (independent BSSs). An apparatus can find out which networks are available, but it cannot find out which individual apparatuses are part of the network. It is therefore impossible to discover the presence of other apparatuses connected to an Access Point (AP). Even if the presence of an apparatus were known, the user's local apparatus could not estimate the distance between the apparatus and the local user's apparatus. An apparatus can only estimate the distance between itself and a WLAN infrastructure by measuring the received signal strengths, but it cannot estimate the distance to other apparatuses.

It is an object of the present invention to provide a method with which an apparatus can be put into the position of identifying the available apparatuses and services in its proximity.

It was found that the distance between a WLAN-capable portable apparatus and other apparatuses and services, i.e. its relative position to them can be determined and used when the apparatuses to be discovered in the local wireless network periodically build up their own Ad Hoc Networks.

It is an object of the present invention to provide a method of discovering proximate apparatuses and services in a wireless network with at least one Access Point (AP), wherein an apparatus to be discovered periodically separates itself from its Access Point and builds up its own Ad Hoc Network (AHN) which can be recognized via its Service Set Identifier (SSID) by a searching apparatus.

The method according to the invention enables a WLAN-capable apparatus connected to an Access Point to discover and identify other proximate apparatuses and their services. In this way, new proximity-based applications become possible. Moreover, the method according to the invention has the advantage that the infrastructure of the WLAN does not need to be changed. The method according to the invention is directly applicable for use with available apparatuses because the WLAN technology is already widely used.

The method according to the invention is particularly suitable when a user having a wireless mobile apparatus would like to discover and use services in his proximity. Examples of such services are printer, projector, music player and imaging services.

Both the mobile apparatus of the user (hereinafter also referred to as “searching apparatus”) and the apparatuses providing services (hereinafter also referred to as “apparatuses to be discovered”) are connected to at least one WLAN Access Points so that they can communicate with each other.

Dependent on the output, the range covered by an Access Point may vary. Ranges of about 100 meters are achieved in buildings when using the conventional full power output. A plurality of Access Points may be interconnected to one large wireless network via a distribution system so as to cover, for example, a building completely.

In the method according to the invention, the searching apparatus initially discovers all those apparatuses to be discovered that are in its proximity. When at least one other apparatus is discovered in the proximity of the searching apparatus, the search for services in the apparatuses that have been found can be performed in a second step of the method according to the invention, as described below.

According to the invention, to be discoverable for the searching apparatus, the apparatuses to be discovered separate themselves periodically from their Access Point for a short period of time and build up their own Ad Hoc Network. This Ad Hoc Network can then be found by apparatuses other than the searching apparatus. Dependent on the power output of the WLAN cards, the range covered by such an Ad Hoc Network may vary. At the current, customary full power output, ranges of about 100 meters are achieved in buildings. In the preferred variant of the method according to the invention, the Ad Hoc Network (AHN) does not comprise any other elements, apart from the apparatus it has generated.

In this way, a plurality of mutually independent Ad Hoc Networks is built up periodically within a WLAN, dependent on the number of apparatuses to be discovered, all of which Ad Hoc Networks comprise only one element, namely the apparatus that is to be discovered. When generating its own Ad Hoc Network, the apparatus supplies its identification name so as to be unambiguously identifiable. To this end, the Service Set Identifier (SSID) of the Ad Hoc Network (AHN) includes an unambiguous identification name of the apparatus (UUID) in the preferred method according to the invention.

The Service Set Identifier (SSID) of the Ad Hoc Network (AHN) provided by the apparatus to be discovered should be different from the SSID of the Access Points, which can be effected, for example, by means of a prefix and/or a suffix. In this way, the relevant SSID can be unambiguously assigned to an apparatus. A searching apparatus (for example, a user's Notebook) can now periodically retrieve the list of visible SSIDs from its WLAN transceiver. When an apparatus to be discovered (for example, a UHP projector) has made itself discoverable for the searching apparatus in the manner described hereinbefore, the SSID of the apparatus to be discovered appears on this list.

The classification of the different discovered apparatuses as to proximity or remoteness is made possible by means of the method according to the invention in that the searching apparatus queries, via its WLAN transceiver, the signal strength of the apparatuses that have been found. This information is available because every apparatus that has been found is observed as an independent Ad Hoc Network. The higher the signal strength for an apparatus that has been found, the closer it is situated to the searching apparatus. In a preferred method according to the invention, the searching apparatus classifies the apparatuses that have been found with a signal strength of more than −60 dBm as proximate apparatuses. In a second variant, the searching apparatus classifies the apparatuses that have been found in accordance with their remoteness so that the list thereby produced, or the upper segment of the list, can be indicated to the user.

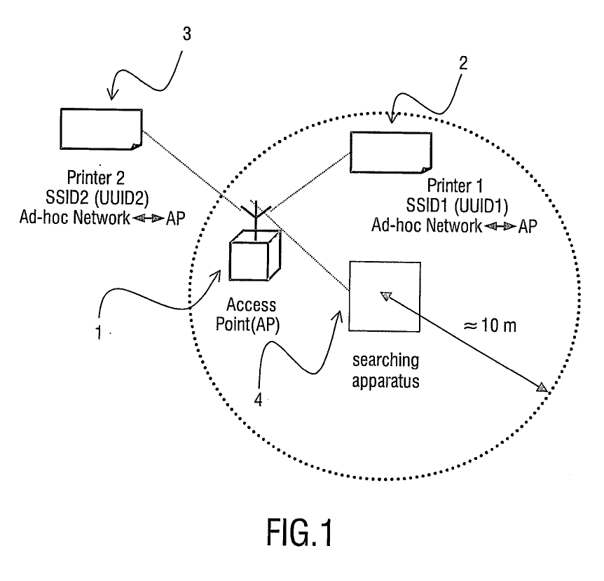

The method according to the invention will be elucidated with reference to FIG. 1.

FIG. 1 shows an arrangement of apparatuses for performing the method according to the invention for discovering proximate apparatuses and services in a wireless network.

As is shown in FIG. 1, a proximate apparatus 2 to be discovered and a remote apparatus to be discovered are connected to an Access Point (AP) 1 and periodically separate themselves from this Access Point so as to build up their own Ad Hoc Network. A searching apparatus 4 searching services in its close proximity (for example with a radius of 10 meters) receives a list of SSIDs with the associated signal strengths. If the Access Point 1 has a signal strength of, for example, −32 dBm, −37 dBm for the apparatus 2 and −65 dBm for the apparatus 3, the searching apparatus 1 can identify apparatus 2 as a proximate apparatus with reference to these signal strengths.

In the manner described hereinbefore, the user of the searching apparatus acquires a list of those apparatuses to be discovered that are in his proximity. To find out whether a service desired by the user is available in his proximity, the method according to the invention can be performed in such a way that, by means of a Discovery Framework, preferably by means of Universal Plug&Play (UPnP), the searching apparatus is capable of accessing the services of the apparatus to be discovered.

In this variant of the method, the searching apparatus starts a UPnP search by means of the discovered UUID after it has discovered at least one apparatus in its proximity. UPNP ensures that the searching apparatus finds and can use the services offered by the other apparatus. The user can then be informed about appropriate services in its proximity.

In the preferred method according to the invention, the searching apparatus finds, by means of a Universal Plug&Play (UPnP) search among the proximate apparatuses, that apparatus which provides the desired service.

The method described hereinbefore, by which a searching apparatus identifies apparatuses to be discovered and estimates their distance can also be performed after a UPnP search. First, all desired services that are available in the network are discovered by means of UPnP and subsequently it is determined which services are in the user's proximity.

Accordingly, methods according to the invention in which the searching apparatus initially discovers all desired services available in the network by means of UPnP and subsequently determines which services are in its proximity, are also preferred.

According to the invention, an apparatus to be discovered separates itself periodically from its Access Point for a short period of time so as to build up its own Ad Hoc Network. To prevent disturbances and possibly active communication between the apparatuses to be discovered, the periods of time in which the apparatus to be discovered is separated from its Access Point should be short. In this case, methods according to the invention are preferred wherein the period of time in which the apparatus to be discovered is separated from its Access Point is maximally 1 s, preferably maximally 100 ms, particularly preferably maximally 50 ms and particularly maximally 10 ms.

The more frequently an apparatus to be discovered separates itself from its Access Point so as to build up its own Ad Hoc Network, the faster it can be found by searching apparatuses because they do not need to wait too long for an update of the SSID list. In the preferred method according to the invention, the repetition frequency of separation of the apparatus to be discovered from its Access Point is 0.5 to 100 Hz, preferably 2 to 80 Hz, particularly preferably 5 to 60 Hz and particularly 10 to 50 Hz.

### List of Reference Numerals

1 Access Point (AP)
2 proximate apparatus to be discovered
3 remote apparatus to be discovered
4 searching apparatus

1. A method of discovering proximate apparatuses and services in a wireless network with at least one Access Point (AP), wherein an apparatus to be discovered periodically separates itself from its Access Point and builds up its own Ad Hoc Network (AHN) which can be recognized via its Service Set Identifier (SSID) by a searching apparatus.

2. A method as claimed in claim 1, wherein the Ad Hoc Network (AHN) does not comprise any further elements apart from the apparatus it has generated.

3. A method as claimed in claim 1, wherein the Service Set Identifier (SSID) of the Ad Hoc Network (AHN) includes an unambiguous identification name of the apparatus (UUID).

4. A method as claimed in claim 1, wherein the searching apparatus queries, via its WLAN transceiver, the signal strength of the apparatuses that have been found.

5. A method as claimed in claim 4, wherein the searching apparatus classifies the apparatuses that have been found with a signal strength of more than −60 dBm as proximate apparatuses.

6. A method as claimed in claim 1, wherein, by means of a Discovery Framework, preferably by means of Universal Plug&Play (UPnP), the searching apparatus is capable of accessing, the services of the apparatus to be discovered.

7. A method as claimed in claim 6, wherein, by means of a Universal Plug&Play (UPnP) search among the proximate apparatuses, the searching apparatus finds that apparatus which provides the desired services.

8. A method as claimed in claim 6, wherein the searching apparatus initially discovers all desired services available in the network by means of UPnP and subsequently determines which services are in its proximity.

9. A method as claimed in claim 1, wherein the period of time in which the apparatus to be discovered is separated from its Access Point is maximally 1 s, preferably maximally 100 ms, particularly preferably maximally 50 ms and particularly maximally 10 ms.

10. A method as claimed in claim 1, wherein the repetition frequency at which the apparatus to be discovered is separated from its Access Point is 0.5 to 100 Hz, preferably 2 to 80 Hz, particularly preferably 5 to 60 Hz and particularly 10 to 50 Hz.
